(19) United States
(12) Patent Application Publication
(10) Pub. No.: US 2015/0256446 A1
(43) Pub. Date: Sep. 10, 2015

(54) METHOD AND APPARATUS FOR RELAYING COMMANDS

(71) Applicant: FUJITSU LIMITED, Kawasaki-shi (JP)

(72) Inventor: Tsunehisa Doi, Kawasaki (JP)

(21) Appl. No.: 14/610,389

(22) Filed: Jan. 30, 2015

(30) Foreign Application Priority Data
Mar. 10, 2014 (JP) 2014-045982

(51) Int. Cl. H04L 12/721; H04L 29/06; H04L 29/08

(52) U.S. Cl. CPC H04L 45/14; H04L 67/10; H04L 67/42

(57) ABSTRACT

A first receiving unit receives first update commands from a first information processing apparatus. These first update commands specify updates to an operation screen image for the first information processing apparatus. A second receiving unit receives second update commands from the second information processing apparatus. These second update commands specify updates to an operation screen image for the second information processing apparatus. A detection unit detects completion of a migration from the first information processing apparatus to the second information processing apparatus, based on the received first and second update commands. A forwarding unit forwards the received first update commands to a terminal device until the migration is started. The forwarding unit starts to forward the received second update commands to the terminal device when completion of the migration is detected.

### CROSS-REFERENCE TO RELATED APPLICATION

This application is based upon and claims the benefit of priority of the prior Japanese Patent Application No. 2014-045982, filed on Mar. 10, 2014, the entire contents of which are incorporated herein by reference.

### FIELD

The embodiments discussed herein relate to a method and apparatus for relaying commands.

### BACKGROUND

Infrastructure as a Service (IaaS) is one of the basic models of information and communication services. With IaaS services, an information and communications system is operated and managed from a remotely located device. For example, IaaS allows a user terminal device to connect as a remote console to a physical server that the service provider deploys. Remote console mechanisms permit the use of a terminal device as a console for input and output operations on a physical server through their network connection. For example, the operator enters commands to or obtains information from a physical server by using a console even before the operating system (OS) starts up on that server.

Remote console functions are implemented on, for example, a relaying device placed between a physical server and a terminal device. The relaying device transfers input data from the terminal to the physical server, besides forwarding display data for console screen from the physical server to the terminal device.

There are several existing techniques for management of servers. For example, one proposed computer system permits a single console terminal to manage a plurality of computing devices. This computer system has the capability of changing its own device configuration without stopping programs running in the system. Another example is a virtual machine management system that manipulates virtual machines running on a physical server by using captured video images of the physical server. Yet another example is about a technique for migration of physical servers. The proposed migration technique reduces service downtime, ensures access transparency and location transparency, and enables daily operations without performance degradation. See, for example, the following patent publications:
Japanese Laid-open Patent Publication No. 5-197699
International Publication Pamphlet No. W02010/113466
Japanese Laid-open Patent Publication No. 2006-190141

The conventional remote console functions do not assume the use with a live migration of physical servers, thus being unable to automatically follow the move of the operating system. For example, an IaaS-based system may sometimes need to execute a migration from a working physical server to another machine for the purpose of maintenance or the like. There may be, however, a user who has been using remote console functions to connect his or her terminal device to the server. When this is the case, the user's remote console environment would not move together with the operating system migrating to a new physical server.

One cause of the above problem relates to the configuration of networks used to realize the remote console functions. Specifically, the remote console functions assume the use of a management network, provided separately from normal networks, to interconnect a user terminal device and a physical server. There is also a relaying device that intervenes between their communication because of a security concern or other reasons. While being able to recognize a move of the environment to a new physical server on the basis of an advanced notice of migration from a management server or the like, the relaying device has no information about when the migration is finished or when the new physical server starts up. The relaying device consequently keeps connecting the user terminal device to the initial physical server, although the operating system is actually running on a different physical server. The screen of the user terminal device is therefore frozen or may even go into a blank.

### SUMMARY

In one aspect of the embodiments to be discussed herein, there is provided a non-transitory computer-readable storage medium storing a program for relaying commands. This program causes a computer to perform a process including the following operations: receiving first update commands from a first information processing apparatus and forwarding the received first update commands to a terminal device, the first update commands specifying updates to an image of an operation screen for the first information processing apparatus; receiving second update commands from a second information processing apparatus to which an operating system of the first information processing apparatus is to migrate, the received second update commands specifying updates to an image of an operation screen for the second information processing apparatus; detecting completion of a migration of the operating system from the first information processing apparatus to the second information processing apparatus, based on the received first and second update commands; and starting to forward further second update commands from the second information processing apparatus to the terminal device while stopping the forwarding of the first update commands, when completion of the migration of the operating system is detected.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary system configuration according to a first embodiment;

FIG. 2 illustrates an exemplary system configuration according to a second embodiment;

FIG. 3 illustrates an exemplary hardware configuration of a relaying server for remote consoles;

FIG. 4 is a functional block diagram illustrating several devices constituting the second embodiment;

FIG. 5 illustrates an example of data stored in a management data storage unit;

FIG. 6 is a sequence diagram illustrating a connection setup procedure;

FIG. 7 illustrates an example of a migration process;

FIG. 8 is a sequence diagram illustrating a migration procedure;

FIG. 9 is a flowchart illustrating an exemplary procedure of context switch monitoring;

FIG. 10 illustrates an example of how console screen images change with the progress of a migration; and

FIG. 11 illustrates an example of a migration process according to a third embodiment.

### DESCRIPTION OF EMBODIMENTS

Several embodiments and their variations will be described below with reference to the accompanying drawings. These embodiments may be combined with each other, unless they have contradictory features.

### (a) First Embodiment

The first embodiment discussed herein is directed to a function of changing the connection of a remote console, as part of a migration of a system (e.g., operating system) that runs on an information processing apparatus (e.g., physical server) to another such apparatus. This function is particularly useful in the case of manipulating physical servers from a remote console under the IaaS model.

The noted use of remote console functions in IaaS has the following advantages over remote desktop, another kind of functions for controlling remote servers.

Remote desktop permits one computer to remotely control another computer via a network. Once built on a computer, the remote desktop environment will automatically migrate together with OS of that computer because remote desktop is provided as an OS service. OS-based services are, however, available only when the OS is in operation, and this fact imposes some limitations on the usability of remote desktop functions. For example, remote desktop users are unable to manipulate their server from Basic Input/Output System (BIOS) setup screens since it is before the OS starts up. It is also impossible to check the condition of a server when its OS has become abnormal. In contrast, remote console functions are free from those limitations, thus providing the capability of remotely controlling a server even before its OS starts up.

As can be seen from the above, remote console functions are important for the IaaS users to manipulate their servers. The provider of IaaS services, on the other hand, performs a migration of server OS for their own reasons, such as maintenance of server hardware. It is desirable to execute this type of migration without disturbing operations on the user side. When moving an active OS to a new physical server, the remote console has also to be reconfigured so as to change its connection to the new server. This migration of remote console functions, however, would not be achieved by simply moving the OS because they are provided separately from the OS.

In view of the above, the first embodiment offers a mechanism that enables remote console functions to follow a migration of information processing apparatuses. More particularly, the first embodiment integrates a connection switching function into a relaying apparatus that acts as an intermediary between a remote console terminal and an information processing apparatus.

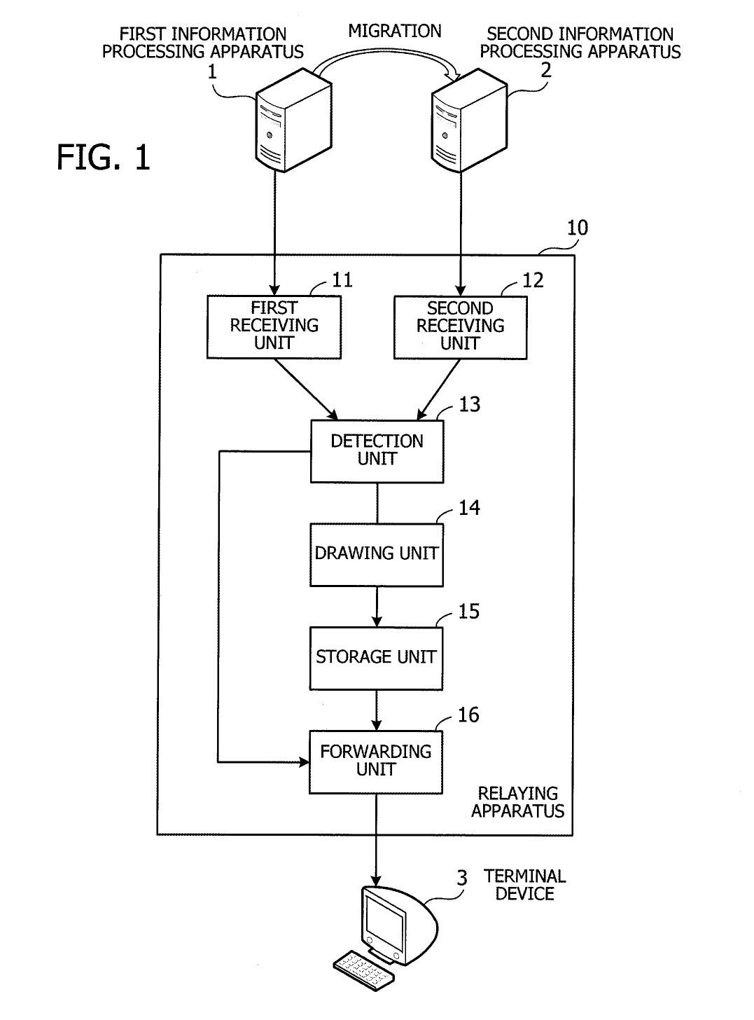

FIG. 1 illustrates an exemplary system configuration according to the first embodiment. The illustrated system includes first and second information processing apparatuses 1 and 2 having migration functions.

More specifically, a migration process moves the OS currently running on the first information processing apparatus 1 to the second information processing apparatus 2, as well as application software programs (or simply “applications”) executing on that OS. The following description may use the term “program migration” to refer to a migration process for OS and application programs.

Both the first and second information processing apparatuses 1 and 2 have the capability of connecting with a remote console. When a terminal device is connected as a remote console, the first information processing apparatus 1, as well as the second information processing apparatus 2, outputs update commands to the terminal device to update what is seen on its operation screen. Referring to the example of FIG. 1, one terminal device 3 is connected initially (i.e., before migration) to the first information processing apparatus 1 as its remote console. This connection is via a relaying apparatus 10 described below.

The illustrated relaying apparatus 10 includes a first receiving unit 11, a second receiving unit 12, a detection unit 13, a drawing unit 14, a storage unit 15, and a forwarding unit 16. The first receiving unit 11 is to receive update commands from the first information processing apparatus 1. These commands request the receiving terminal to update its operation screen image for the first information processing apparatus 1. The second receiving unit 12 is to receive update commands similar to the above, but from the second information processing apparatus 2. These update commands request the receiving terminal to update its operation screen image for the second information processing apparatus 2 with a new image. To distinguish the source of update commands, the following description of the first embodiment uses the term “first update commands” to refer to those issued by the first information processing apparatus 1 and the term “second update commands” to refer to those issued by the second information processing apparatus 2.

The detection unit 13 is to detect completion of a migration process that moves OS and applications from the first information processing apparatus 1 to the second information processing apparatus 2. The detection unit 13 achieves this detection on the basis of first update commands received from the first information processing apparatus 1 and second update commands from the second information processing apparatus 2. For example, the detection unit 13 recognizes completion of a program migration process when the following two conditions are true: (a) the first information processing apparatus 1 has stopped its OS, and (b) the second information processing apparatus 2 has started its OS. More specifically, the former condition (a) holds true when the detection unit 13 sees no more first update commands coming from the first information processing apparatus 1. The latter condition (b) holds true when the detection unit 13 finds second update commands coming again from the second information processing apparatus 2 after the second information processing apparatus 2 stays silent (i.e., no second update commands) for a while.

The drawing unit 14 is to draw an image in the storage unit 15 according to each first update command received from the first information processing apparatus 1 until a program migration process is started. When the program migration process is finished, the drawing unit 14 switches the source of update commands and begins to draw an image in the storage unit 15 according to second update commands received from the second information processing apparatus 2. The storage unit 15 provides a memory space for an operation screen image to be displayed on the remote console.

The forwarding unit 16 is to forward first update commands from the first information processing apparatus 1 to the terminal device 3 until a program migration process is started. When the program migration process is finished, the forwarding unit 16 stops forwarding first update commands and, instead, starts forwarding second update commands from the second information processing apparatus 2 to the terminal device 3. The forwarding unit 16 further transmits an image from the storage unit 15 to the terminal device 3 when so requested for display as an operation screen.

In operation of the above system, the first information processing apparatus 1 issues first update commands to update its operation screen on the terminal device 3. This is performed during the time that the OS and applications are running on the first information processing apparatus 1 before a program migration is started. The issued first update commands are received by the first receiving unit 11 in the relaying apparatus 10 and sent to the forwarding unit 16 via the detection unit 13. The forwarding unit 16 transmits these update commands to the terminal device 3.

Suppose now that a program migration process from the first information processing apparatus 1 to the second information processing apparatus 2 is started.

When activated, the second information processing apparatus 2 (destination apparatus) begins to output its own update commands for its operation screen. These second update commands are received by the second receiving unit 12 in the relaying apparatus 10. During this transitional period, the first receiving unit 11 also receives first update commands from the first information processing apparatus 1. The detection unit 13 detects whether the program migration to the second information processing apparatus 2 is finished, based on the received first update commands and second update commands. Upon completion of the program migration, the forwarding unit 16 begins forwarding second update commands from the second information processing apparatus 2 to the terminal device 3, while stopping the forwarding operations of first update commands.

The remote console connection of the terminal device 3 is switched from the first information processing apparatus 1 to the second information processing apparatus 2 in the way described above, following a migration of OS and application programs in that direction. That is, the proposed relaying apparatus automatically switches the connection of a remote console in accordance with the progress of a program migration.

The drawing unit 14 is configured to draw images in its local storage unit 15 according to first update commands received from the first information processing apparatus 1 until a program migration is started. The drawing unit 14 does the same for second update commands received from the second information processing apparatus 2 after the program migration process is finished. The storage unit 15 thus holds the latest operation screen while the OS is running. Upon request for an operation screen image from the terminal device 3 during the program migration process, the forwarding unit 16 reads the image out of the storage unit 15 and sends it to the terminal device 3. The relaying apparatus 10 thus eliminates the need for the terminal device 3 to update its screen image even if the first and second information processing apparatuses 1 and issue their update commands during the course of a program migration process. In other words, it enables the OS and application programs to migrate transparently to the user of the terminal device 3.

While the above example has illustrated how the relaying apparatus 10 handles update commands sent from the first information processing apparatus 1 or second information processing apparatus 2 to the terminal device 3, there is also a case for the terminal device 3 to send user instructions (operation commands) to the relaying apparatus 10. The forwarding unit 16 is thus configured to forward user instructions issued from the terminal device 3 to either the first information processing apparatus 1 or the second information processing apparatus 2, whichever appropriate. For example, the forwarding unit 16 forwards such instructions to the first information processing apparatus 1 before a migration is started. When completion of a program migration process is detected, the forwarding unit 16 starts forwarding subsequent user instructions from the terminal device 3 to the second information processing apparatus 2.

The above-described first receiving unit 11, second receiving unit 12, detection unit 13, drawing unit 14, and forwarding unit 16 may be implemented as, for example, functions of a processor in the relaying apparatus 10. Likewise, the storage unit 15 may be implemented by using memory devices that the relaying apparatus 10 includes.

It is also noted that the lines interconnecting the functional blocks in FIG. 1 represent some of their communication paths. The person skilled in the art would appreciate that there may be other communication paths in actual implementations.

### (b) Second Embodiment

This section describes a second embodiment, which employs a server to implement command relaying functions for remote consoles. These functions are encoded in a software program for execution by that server such that the server will act as a plurality of relaying devices for individual console users.

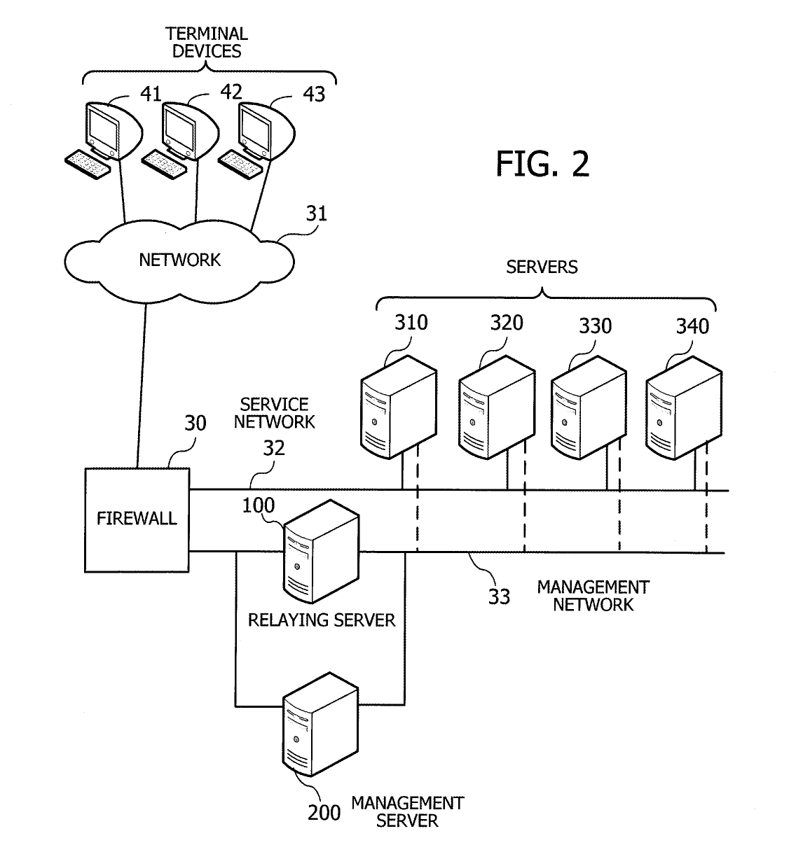

FIG. 2 illustrates an exemplary system configuration according to the second embodiment. The illustrated system includes a plurality of servers 310, 320, 330, and 340 connected to a firewall 30 via a service network 32. The firewall 30 is connected to a plurality of terminal devices 41, 42, and 43 via another network 31. Each terminal device 41 to 43 is a computer whose user has held a contract with an IaaS provider. Each server 310 to 340 is a computer remotely accessible to the terminal devices 41 to 43.

The firewall 30 blocks unauthorized access to the system via the network 31, while permitting a service request from the terminal device 41 to 43 of an authorized IaaS user to reach one of the servers 310 to 340. Referring to FIG. 2, further coupled to the firewall 30 are a relaying server 100 and a management server 200.

The relaying server 100 is connected to the plurality of servers 310 to 340 via a management network 33. The relaying server 100 is a computer configured to play an intermediary role in data communication between a console terminal device and one of the servers 310 to 340.

The management server 200 is linked to the servers 310 to 340 and relaying server 100 via the management network 33. The management server 200 is a computer that manages IaaS services using those servers 310 to 340. For example, the management server 200 controls the servers 310 to 340 to execute a live migration from server to server. The management server 200 is also capable of sending the relaying server 100 some commands about data relaying operations for remote consoles.

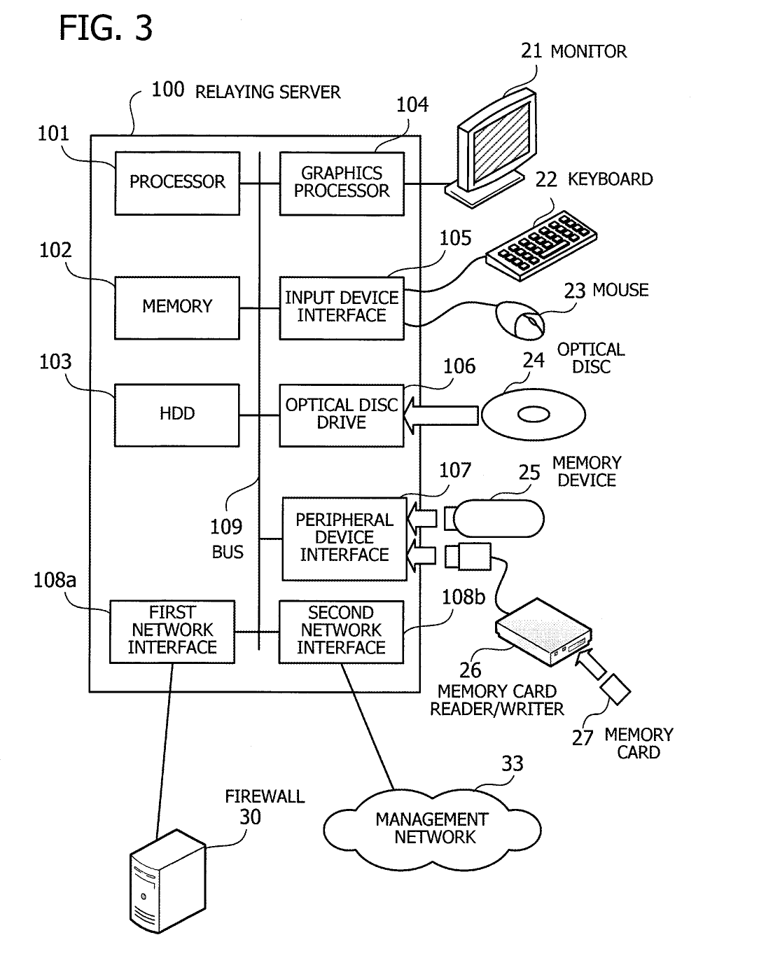

FIG. 3 illustrates an exemplary hardware configuration of a relaying server for remote consoles. The illustrated relaying server 100 has a processor 101 to control its entire operation. The processor 101 is connected to a memory 102 and other various devices and interfaces on a bus 109. The processor 101 may be a single processing device or a multiprocessor system including two or more processing devices. For example, the processor 101 may be implemented as a central processing unit (CPU), micro processing unit (MPU), digital signal processor (DSP), or any combination of them. It is also possible to implement the processing functions of the processor 101 wholly or partly by using an application-specific integrated circuit (ASIC), programmable logic device (PLD), or other electronic circuits, or any combination of them.

The memory 102 serves as a primary storage device in the relaying server 100. Specifically, the memory 102 is used to temporarily store at least some of the OS programs and application programs that the processor 101 executes, in addition to other various data objects that it manipulates at runtime. The memory 102 may be implemented by using, for example, random access memory (RAM), or other volatile semiconductor storage devices.

Other devices on the bus 109 include a hard disk drive (HDD) 103, a graphics processor 104, an input device interface 105, an optical disc drive 106, a peripheral device interface 107, a first network interface 108a, and a second network interface 108b.

The HDD 103 writes and reads data magnetically on its internal platters. The HDD 103 serves as a secondary storage device in the relaying server 100 to store program files of OS and applications, as well as various data files. Flash memory and other semiconductor memory devices may also be used as secondary storage devices, similarly to the HDD 103.

The graphics processor 104, coupled to a monitor 21, produces images in accordance with drawing commands from the processor 101 and displays them on a screen of the monitor 21. The monitor 21 may be, for example, a cathode ray tube (CRT) display or a liquid crystal display.

The input device interface 105 is connected to input devices such as a keyboard 22 and a mouse 23 and supplies signals from those devices to the processor 101. The mouse 23 is an example of pointing devices suitable for the relaying server 100, which may be replaced with other kind of pointing devices such as a touchscreen, tablet, touchpad, and trackball.

The optical disc drive 106 reads out data encoded on an optical disc 24, by using laser light. The optical disc 24 is a portable data storage medium, the data recorded on which can be read as a reflection of light or the lack of the same. For example, the optical disc 24 may be a digital versatile disc (DVD), DVD-RAM, compact disc read-only memory (CD-ROM), CD-Recordable (CD-R), or CD-Rewritable (CD-RW).

The peripheral device interface 107 is a communication interface used to connect peripheral devices to the relaying server 100. For example, the peripheral device interface 107 may be used to connect a memory device 25 and a memory card reader/writer 26. The memory device 25 is a data storage medium having a capability to communicate with the peripheral device interface 107. The memory card reader/writer 26 is an adapter used to write data to or read data from a memory card 27, which is a data storage medium in the form of a small card.

The first network interface 108a is connected to a firewall 30, permitting the processor 101 to communicate with terminal devices 41 to 43 (not depicted in FIG. 3) via a firewall 30. The second network interface 108b is, on the other hand, connected to a management network 33. The second network interface 108b permits the processor 101 to communicate with servers 310 320, 330, and 340 and a management server 200 (not depicted in FIG. 3) via the management network 33.

The hardware platform discussed above in FIG. 3 is used to implement proposed processing functions of the relaying server 100 according to the second embodiment.

The same or similar hardware configuration may apply to other apparatuses discussed previously in the first embodiment, including the firewall 30, management server 200, and servers 310, 320, 330, and 340.

The relaying server 100 and management server 200 provide various processing functions of the second embodiment by executing programs stored in computer-readable storage media. These programs may be encoded in various computer-readable storage media. For example, the relaying server 100 or management server 200 may have programs files in their respective HDDs 103. Their processor 101 reads out at least part of the programs from the HDD 103, loads them into memory 102, and executes the loaded programs. Other possible computer-readable storage media include optical discs 24, memory devices 25, memory cards 27, and other portable media. The programs stored in a portable storage medium are installed in the HDD 103 under the control of the processor 101, so that they are ready to execute upon request. It may also be possible for the processor 101 to execute program codes read out of a portable storage medium, without installing them in its local storage devices.

As seen in FIG. 2, the second embodiment includes various devices. The following section will describe the functions that those devices provide to realize the second embodiment.

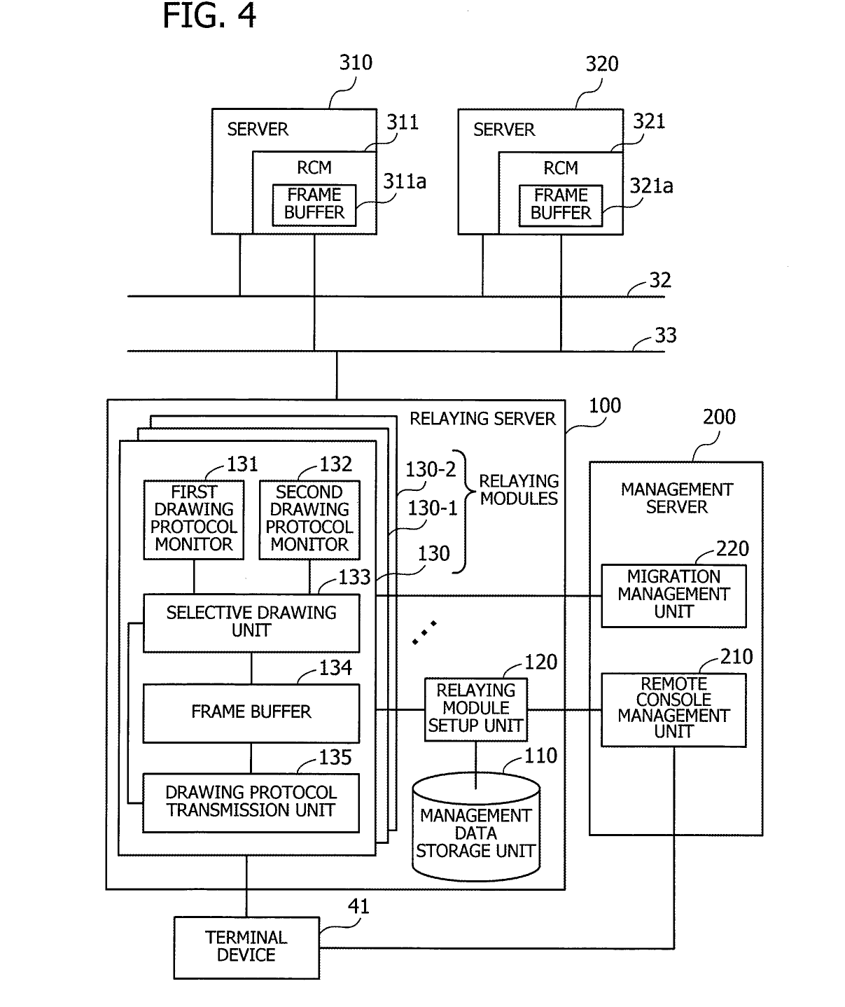

FIG. 4 is a functional block diagram illustrating several devices constituting the second embodiment. Two servers 310 and 320 include remote console function modules (RCMs) 311 and 321 to allow remote terminal devices to work as their consoles. The RCMs 311 and 321 handle data that the servers 310 and 320 output to console terminal devices. Specific network protocols are used to transmit the data to intended terminal devices over the management network 33. The RCMs 311 and 321 also receive data that the console terminal devices send to their associated servers 310 and 320.

For example, the RCMs 311 and 321 have frame buffers 311a and 321a for use in drawing a screen image to be displayed on their associated console terminals.

The RCMs 311 and 321 transmit image data in the frame buffers 311a and 321a to remote terminal devices via the management network 33.

Referring to the bottom-right quarter of FIG. 4, the management server 200 includes a remote console management unit 210 and a migration management unit 220. These components provide the functions described below.

The remote console management unit 210 manages data relaying functions that the relaying server 100 performs for remote consoles. For example, the remote console management unit 210 sends the relaying server 100 a relaying module setup command in response to a console connection request from a terminal device.

The migration management unit 220 manages a live migration process between two servers 310 and 320. For example, the migration management unit 220 sends the servers 310 and 320 a command initiating a live migration in response to a migration command entered by a system administrator. Suppose, for example, that a live migration is to move the OS running on one server 310 to another server 320. In this case, the migration management unit 220 transmits a migration command to the source server 310 and a migration acceptance command to the destination server 320. The source server 310 may have been serving a terminal device connected as a remote console. When this is the case, the migration management unit 220 issues a migration preparation command to the relaying server 100 before starting the migration. This migration preparation command causes the relaying server 100 to detect a move of OS to the destination server and automatically redirect the connection of the terminal device to the destination server.

Referring to the bottom-left part of FIG. 4, the relaying server 100 includes a management data storage unit 110, a relaying module setup unit 120, and a plurality of relaying modules 130, 130-1, and 130-2. These components provide the functions described below.

The management data storage unit 110 stores information that the relaying server 100 uses to implement remote console functions. The stored information indicates, for example, the operating status of each relaying module 130, 130-1, and 130-2. Also included is authentication data for access to the servers 310 and 320. The management data storage unit 110 may be implemented as part of storage space of, for example, the memory 102 or HDD 103.

The illustrated relaying module 130 includes first and second drawing protocol monitors 131 and 132, a selective drawing unit 133, a frame buffer 134, and a drawing protocol transmission unit 135.

The first and second drawing protocol monitors 131 and 132 keep track of update commands issued from each connected server using a certain drawing protocol. Update commands include, for example, draw commands and image data. A draw command directs the act of rendering text or figures or both of them for display on an operation screen of the console. Image data gives a graphic image to be displayed on the same.

While the example seen in FIG. 4 includes two drawing protocol monitors 131 and 132, one drawing protocol monitor 131 may suffice for normal operation of the relaying module 130. An additional drawing protocol monitor 132 is created upon receipt of a migration preparation command from the management server 200. The resulting first and second drawing protocol monitors 131 and 132 forward incoming update commands to the selective drawing unit 133.

The selective drawing unit 133 switches the source of update commands to be executed, depending on whether a migration process is started or not. For example, the selective drawing unit 133 selects update commands received by the first drawing protocol monitor 131 before a migration process is started and draws images in the frame buffer 134 with the selected commands. When it recognizes the start of a migration process (i.e., upon receipt of a migration preparation command from the management server 200), the selective drawing unit 133 watches the traffic of update commands arriving at the first and second drawing protocol monitors 131 and 132 to detect completion of the migration process. Upon completion of the migration, the selective drawing unit 133 switches the command source from the first drawing protocol monitor 131 to the second drawing protocol monitor 132. The selective drawing unit 133 then begins using update commands received by the second drawing protocol monitor 132 to draw images in the frame buffer 134.

The frame buffer 134 stores image data to be transmitted to a terminal device 41 that serves as a remote console terminal. For example, the frame buffer 134 may be implemented as part of storage space of the memory 102.

The drawing protocol transmission unit 135 transmits image data drawn in the frame buffer 134 to the terminal device 41. For example, the drawing protocol transmission unit 135 may simply send the terminal device 41 the update commands that the selective drawing unit 133 has used in drawing images in the frame buffer 134. The drawing protocol transmission unit 135 may also read out all image data stored in the frame buffer 134 and send it to the terminal device 41.

Although FIG. 4 illustrates detailed functions of only one relaying module 130, other relaying modules 130-1, 130-2, and so on also have the same functions in them. It is also noted that the lines interconnecting the elements in FIG. 4 represent some of their communication paths. The person skilled in the art would appreciate that there may be other communication paths in actual implementations. Each element seen in FIG. 4 may be implemented in the form of computer-executable program modules.

The relaying modules 130, 130-1, 130-2, illustrated in FIG. 4 are an exemplary implementation of the relaying apparatus 10 according to the first embodiment, which has been discussed previously in FIG. 1. Similarly, the first drawing protocol monitor 131 in FIG. 4 is an example of the first receiving unit 11 discussed in FIG. 1. The second drawing protocol monitor 132 in FIG. 4 is an example of the second receiving unit 12 discussed in FIG. 1. The selective drawing unit 133 in FIG. 4 is an example of the functions provided by the detection unit 13 and drawing unit 14 discussed in FIG. 1. The frame buffer 134 in FIG. 4 is an example of the storage unit 15 discussed in FIG. 1. The drawing protocol transmission unit 135 in FIG. 4 is an example of the forwarding unit 16 discussed in FIG. 1.

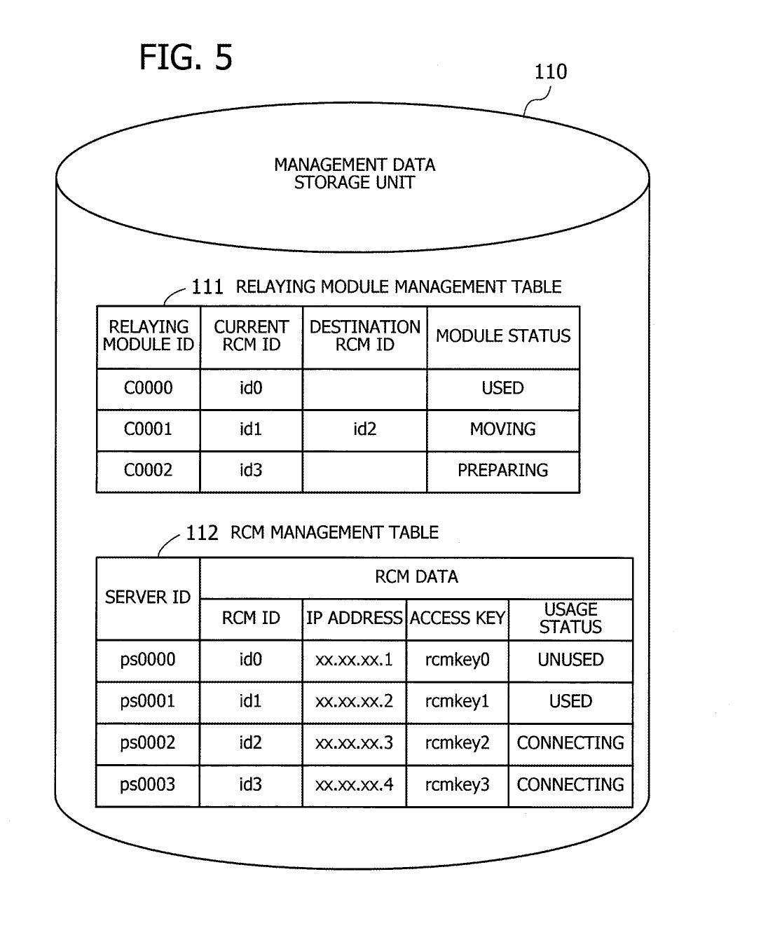

The next section will provide specific details of management data stored in the management data storage unit 110. FIG. 5 illustrates an example of data stored in the management data storage unit 110. Specifically, the illustrated management data storage unit 110 contains a relaying module management table 111 and an RCM management table 112.

The relaying module management table 111 is a data table for managing the status of each relaying module. Specifically, the relaying module management table 111 is formed from the following data fields: Relaying Module ID, Current RCM ID, Destination RCM ID, and Module Status. Relaying Module ID field contains an identifier (ID) that indicates a specific relaying module working in the relaying server 100. Current RCM ID field contains an identifier of RCM (RCM ID) that indicates which RCM is using the relaying module for its communication with a remote console. Destination RCM ID field contains another RCM ID, where applicable, to indicate an RCM in a destination server to which the operating system is to migrate. Module Status field indicates the current usage status of the relaying module as will be detailed below.

The usage status of a relaying module may be expressed as, for example, “Used,” “Moving,” or “Preparing.” The “Used” state means that the relaying module in question is forwarding communication data between its associated server and a terminal device that works as a remote console of that server. The “Moving” state means that the associated server is in the process of a program migration to another server. When an entry of the relaying module management table 111 has a value of “Moving” in its Module Status field, the entry also has a specific RCM ID in its Destination RCM ID field. Otherwise, the destination RCM ID field is empty. The “Preparing” state means that the relaying module in question is preparing itself for data communication between a server and a terminal device (remote console). For example, a relaying module stays in this “Preparing” state when authenticating itself for connection with a server's RCM.

The RCM management table 112 is a data table used to manage various values relating to each RCM implemented in the servers. The illustrated RCM management table 112 is largely divided into two data fields titled “Server ID” and “RCM data.” Server ID field contains an identifier that indicates a specific server, and RCM Data field contains a set of data values relating to an RCM mounted on that server. These values are collectively referred to as the RCM data.

The illustrated RCM Data field is divided into the following four subfields: RCM ID, IP Address, Access Key, and Usage Status. RCM ID subfield contains an identifier indicating a specific RCM, and IP Address subfield contains an IP address at which the RCM is reached. Access Key subfield gives an access key (e.g., a predetermined special character string) used to establish a connection with the RCM. Usage Status subfield indicates the current usage status of the RCM.

The usage status of an RCM may be expressed as “Unused,” “Used,” or “Connecting.” The “Unused” state indicates that the RCM in question is not used to provide remote console functions. The “Used” state means that the RCM is active in communicating with a terminal device via an assigned relaying module. In other words, the RCM is providing remote console functions. The “Connecting” state indicates that the RCM is now setting up a connection with a relaying module in preparation for remote console functions. For example, an RCM stays in this “Preparing” state while it is in the process of authenticating itself for connection with a relaying module.

The following section describes how a connection is established between a server and a terminal device. For illustration, suppose now that a terminal device 41 is to be a remote console terminal of one server 310.

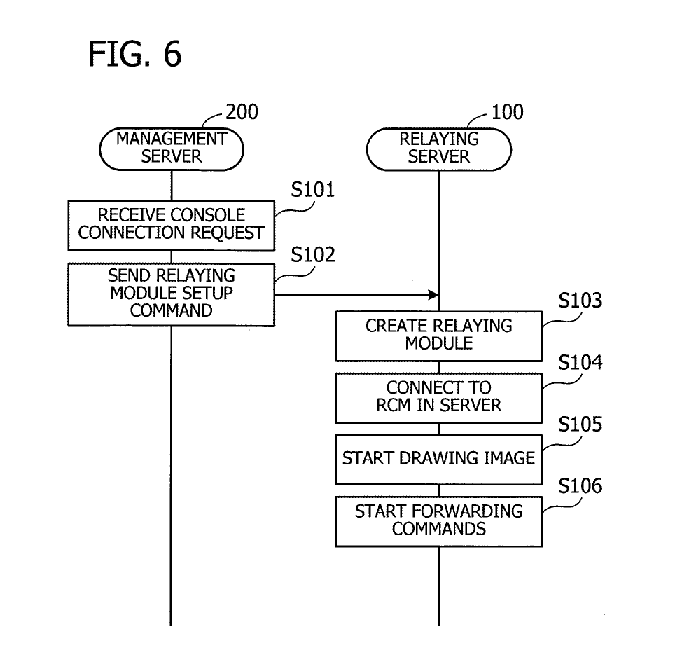

FIG. 6 is a sequence diagram illustrating a connection setup procedure. Each operation in FIG. 6 is described below in the order of step numbers.

(Step S101) Inside the management server 200, the remote console management unit 210 receives a console connection request from the terminal device 41. In the present example, this console connection request carries the server ID of the intended server 310.

(Step S102) The remote console management unit 210 sends the relaying server 100 a relaying module setup command. This relaying module setup command includes, for example, identifiers of the terminal device 41 and RCM 311 in the server 310. The former identifier may actually be, for example, an IP address of the terminal device 41. The latter identifier may be, for example, RCM ID of the RCM 311. IP address and access key of the RCM 311 may also be sent together with its identifier.

(Step S103) Inside the relaying server 100, the relaying module setup unit 120 creates a relaying module 130 in response to the relaying module setup command. For example, the relaying module setup unit 120 invokes a new process that executes a program encoded with the processing functions of a relaying module 130. The relaying module setup unit 120 then extracts IP addresses of the terminal device 41 and RCM 311 from the relaying module setup command and supplies them to the created relaying module 130.

During the course of the above processing, the relaying module setup unit 120 updates data in the management data storage unit 110 by, for example, adding a new record to the relaying module management table 111 to register the created relaying module 130. This new record has the RCM ID of the RCM 311 in its Current RCM ID field and a value of “Preparing” in its Module Status field. The relaying module setup unit 120 further updates the RCM management table 112 with a new value of Usage Status of the RCM 311 in the server 310. More specifically, a value of “Connecting” is given to the table record whose Server ID field contains the ID of the server 310.

(Step S104) The relaying module 130 then connects itself to the specified RCM 311 in the server 310. For example, the relaying module 130 outputs a connection request to the RCM 311, specifying its IP address as the destination. This connection request also includes an access key for the RCM 311. In response, the RCM 311 establishes a connection with the relaying module 130 after confirming that the received access key is proper. The relaying module 130 then sets up a connection with the terminal device 41. These operations permit the terminal device 41 and RCM 311 to establish their network connection via the relaying module 130.

(Step S105) The relaying module 130 begins drawing images in its frame buffer 134 on the basis of update commands from the RCM 311. That is, each subsequent update command from the RCM 311 updates the content in the frame buffer 134, so that the stored image is maintained in the up-to-date state. In other words, the frame buffer 134 contains the latest console image that the terminal device 41 is supposed to display on its screen.

(Step S106) The relaying module 130 starts to forward update commands from the RCM 311 to the terminal device 41 according to a certain drawing protocol. This event also causes the relaying module setup unit 120 to change some data in the management data storage unit 110. For example, the relaying module setup unit 120 updates the RCM management table 112 by setting a value of “Used” in Usage Status field of the record whose Server ID field matches with the server 310.

The above-described steps create a relaying module 130 in the relaying server 100 to permit the RCM 311 in the server 310 to communicate with the terminal device 41 via the relaying module 130 by using a drawing protocol. The user uses his or her terminal device 41 as a remote console terminal of the server 310.

Suppose now that the server 310 needs to move its OS and other software during its operation because, for example, the server 310 experiences frequent memory errors. A live migration of software execution environment is conducted in this case to permit troubleshooting and maintenance of the server 310, without interrupting ongoing services. The following section will discuss a live migration of software from one server 310 to another server 320.

When a terminal device 41 is connected to the source server 310 as its remote console terminal, this connection of the terminal device 41 has also to be switched to the destination server 320 as part of the live migration. The migration process described below thus includes connection switching of the terminal device 41.

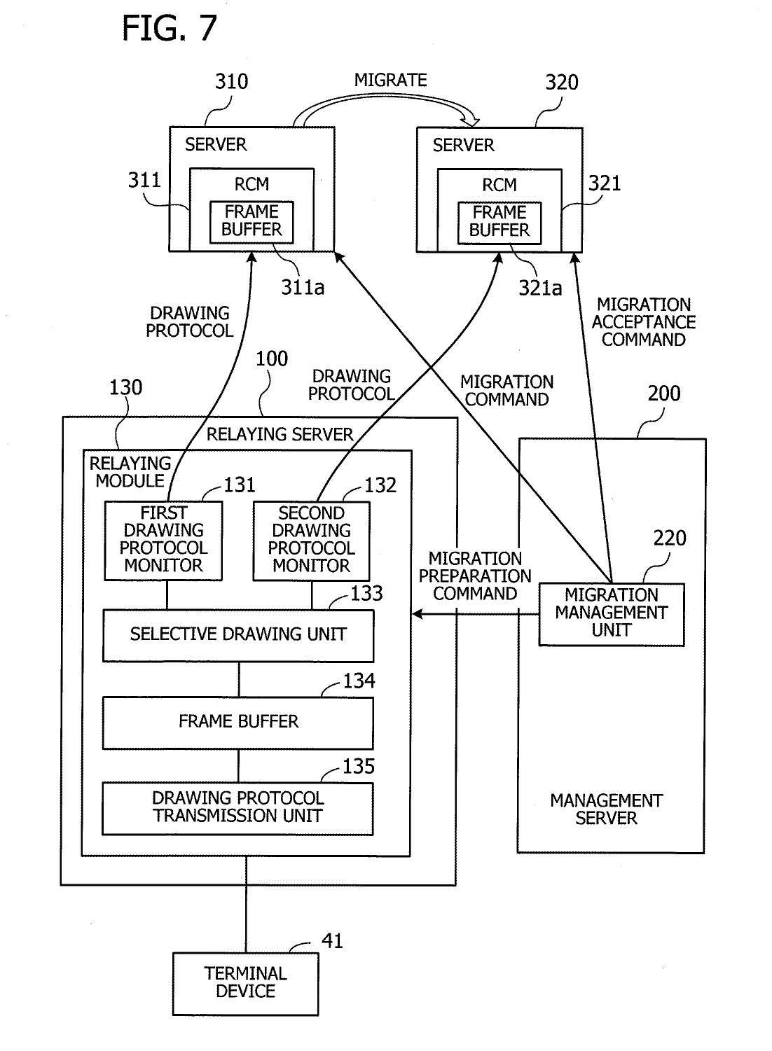

FIG. 7 illustrates an example of a migration process. The migration management unit 220 in the management server 200 sends the relaying server 100 a migration preparation command in response to a request for live migration of one server (source server) 310. Inside the relaying server 100, the relaying module 130 makes a connection to RCM 312 in another server (destination server) 320. The relaying module 130 then creates a second drawing protocol monitor 132 to keep track of drawing protocol communication that the RCM 321 performs. The two drawing protocol monitors 131 and 132 in the relaying module 130 are thus responsible for watching communication activities of the source server 310 and destination server 320, respectively.

The migration management unit 220 commands the source server 310 and destination server 320 to start a migration. A live migration process from the source server 310 to the destination server 320 is thus initiated. Both servers 310 and 320 transmit information about the progress of their live migration process by using the drawing protocol, assuming that their corresponding console terminals will display the information on its screen. The relaying module 130 monitors this drawing protocol communication of the servers 310 and 320, and its selective drawing unit 133 detects completion of the migration process on the basis of what the servers 310 and 320 have transmitted to their remote consoles. Upon detection of completion, the selective drawing unit 133 disconnects the RCM 311 of the source server 310. The relaying module 130 begins using update commands from the RCM 321 in the destination server 320 to draw images in its frame buffer 134, while forwarding those update commands to the terminal device 41.

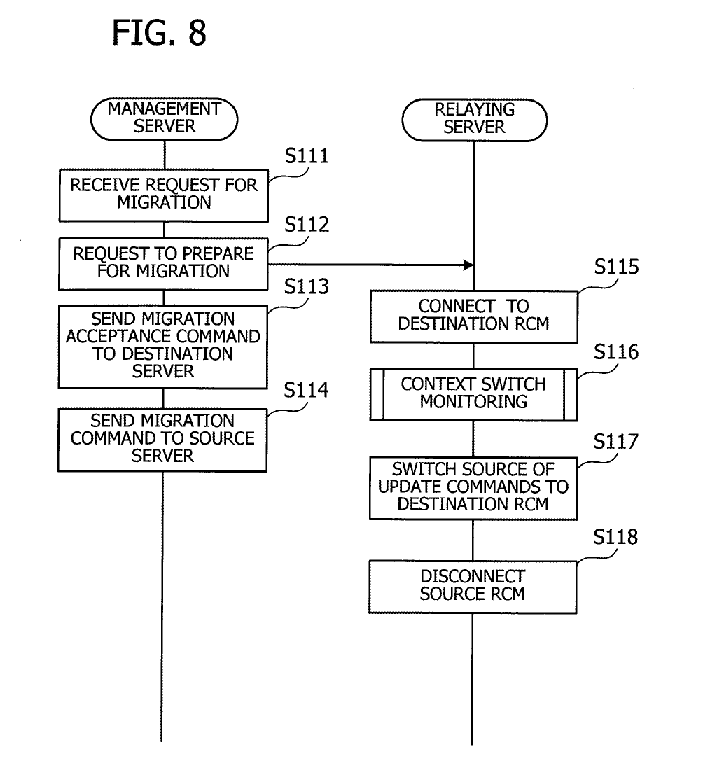

The next section will discuss how the above system executes a migration process, with reference to a sequence diagram. FIG. 8 is a sequence diagram illustrating a migration procedure. Each operation in FIG. 8 is described below in the order of step numbers.

(Step S111) The migration management unit 220 in the management server 200 receives a request for migration. For example, the migration management unit 220 receives an instruction from an administrator of the system, the instruction specifying a source server 310 for migration.

(Step S112) The migration management unit 220 transmits a migration preparation command to the relaying server 100. This migration preparation command includes, for example, server ID and RCM data of the source server 310 and its RCM 311, as well as those of the destination server 320 and its RCM 321. RCM data is made up of, for example, RCM-ID, IP address, access key, and other information. The migration preparation command may omit such RCM data, wholly or partly, when the relaying server 100 already has it in its RCM management table 112.

(Step S113) The migration management unit 220 transmits a migration acceptance command to the destination server 320. For example, the migration management unit 220 remotely controls the destination server 320 so as to power it up. The migration management unit 220 then causes the server 320 to invoke a system that accepts software moving in from another server through a live migration process.

(Step S114) The migration management unit 220 transmits a migration command to the source server 310. This migration command includes, for example, IP address of the destination server 320.

(Step S115) The above migration preparation command from the management server 200 arrives at the relaying server 100. Inside the relaying server 100, the relaying module 130 sets up a connection to the destination server 320, in addition to the existing connection to the source server 310.

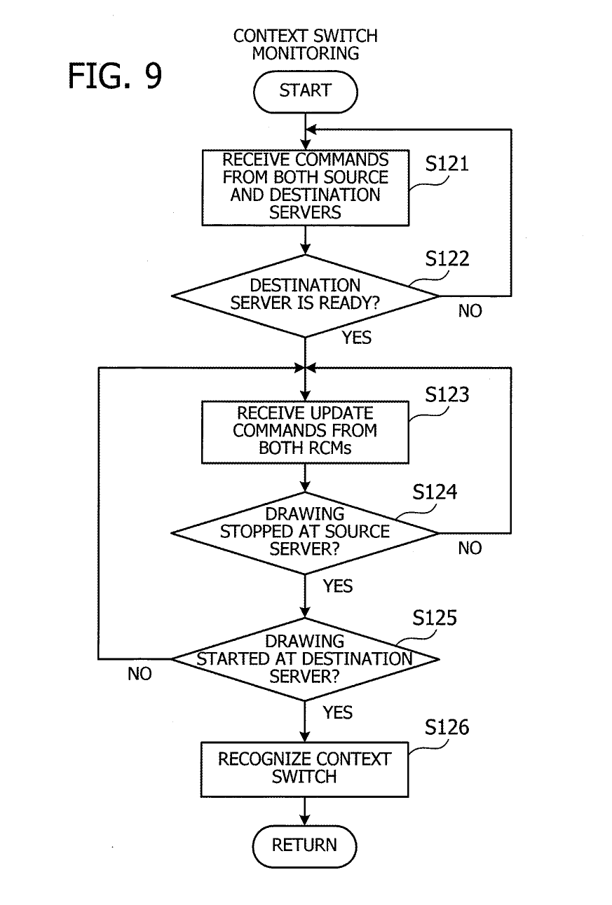

(Step S116) The relaying module 130 executes a context switch monitoring routine. Context switch in terms of migration means the act of reproducing an operating environment (e.g., state of CPU and others) of software in the destination server 320 just as originally in the source server 310. The relaying server 100 proceeds to the next step S117 when the context switch monitoring routine detects the noted act in the servers. Details of the context switch monitoring routine will be described later with reference to FIG. 9.

(Step S117) After checking the context switch, the selective drawing unit 133 in the relaying module 130 switches the source of update commands to the destination RCM 321 (RCM in the destination server 320). The selective drawing unit 133 begins drawing images in the frame buffer 134 according to update commands sent from the destination RCM 321, and the drawing protocol transmission unit 135 forwards those update commands to the terminal device 41.

(Step S118) The selective drawing unit 133 disconnects the RCM 311 in the source server 310. From that time onward, the relaying server 100 forwards update commands from the destination RCM 321 to the terminal device 41, as well as routing commands from the terminal device 41 to the destination RCM 321.

The next section describes in detail how the relaying server 100 executes a context switch monitoring routine. FIG. 9 is a flowchart illustrating an exemplary procedure of context switch monitoring. Each operation in FIG. 9 is described below in the order of step numbers.

(Step S121) The selective drawing unit 133 receives update commands that the drawing protocol delivers from both RCMs 311 and 321 in the source server 310 and destination server 320.

(Step S122) The selective drawing unit 133 determines whether the destination server is ready for migration. For example, the selective drawing unit 133 determines that the destination server 320 is ready when it sees no further update commands coming from the server 320 for a predetermined time. Alternatively, the selective drawing unit 133 may previously register a particular update command that the RCM 321 is expected to output when its preparation is done. When a received update command matches with the registered one, the selective drawing unit 133 recognizes it as indicating the completion of preparation.

The process advances to step S123 when the destination server is found to be ready for migration. Otherwise, the process returns to step S121.

(Step S123) The selective drawing unit 133 continues receiving update commands from both the source RCM 311 and destination RCM 321.

(Step S124) The selective drawing unit 133 determines whether the source server has stopped drawing screen images. For example, the selective drawing unit 133 recognizes that the drawing is stopped, when the source RCM 311 is silent for a specified time or more. The process advances to step S125 when this is the case. Otherwise, the process returns to step S123.

(Step S125) The selective drawing unit 133 determines whether the destination server has started drawing console screen images. For example, the selective drawing unit 133 recognizes drawing activities when it sees update commands coming again from the destination RCM 321. The process advances to step S126 when this is the case. Otherwise, the process returns to step S123.

(Step S126) The selective drawing unit 133 recognizes that the context has been switched. The selective drawing unit 133 thus exits from the context switch monitoring routine and returns to the calling process.

The above-described steps permit the selective drawing unit 133 to detect a context switch during the migration process. This event causes a change in the source of update commands, so that a screen image will be drawn in the frame buffer 134 according to update commands from the destination server.

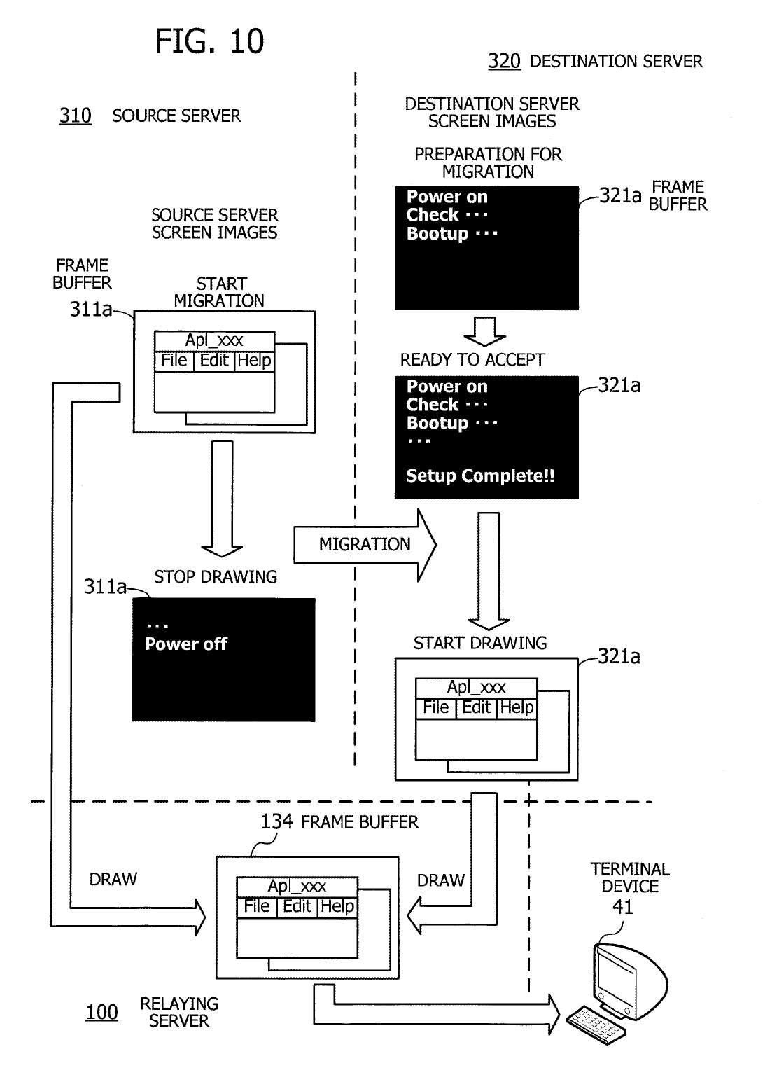

FIG. 10 illustrates an example of how the console screen images change with the progress of a migration. As discussed previously in FIG. 4, the source server 310 and destination server 320 include frame buffers 321a and 311a as part of their RCMs 311 and 321, respectively. As a result of a migration acceptance command issued to the destination server 320, several messages are drawn in its frame buffer 321a to indicate the progress of preparation for a migration. Update commands for these messages are transmitted from the destination RCM 321, and the relaying module 130 receives them with its second drawing protocol monitor 132. These update commands are, however, discarded because the selective drawing unit 133 currently selects the source RCM 311 as the source of update commands for drawing screen images.

The frame buffer 311a in the source RCM 311, on the other hand, contains a screen image drawn from a software program running on the server 310. Update commands for drawing this screen image are transmitted from the source RCM 311, and the relaying module 130 receives them with its first drawing protocol monitor 131. The selective drawing unit 133 in the relaying module 130 executes the received update commands, thus reproducing the same screen image as the above in its local frame buffer 134. When a migration command is received, the source server 310 executes a live migration in coordination with the destination server 320. The live migration process transfers the current context in the memory and registers of the source server 310 to the destination server 320, so that it is duplicated in the memory and registers of the destination server 320.

Upon completion of the migration process, the source server 310 draws a message in the frame buffer 311a of its RCM 311 to indicate, for example, that the server 310 is entering a shutdown sequence. The source server 310 then goes down, and there are no more update commands from its RCM 311. The noted message in the shutdown sequence of the source server 310 makes its way to the relaying module 130 in the form of update commands from the source RCM 311. This message is, however, not drawn in the frame buffer 134 because the selective drawing unit 133 in the relaying module 130 has stopped execution of update commands since the start of the migration process. The selective drawing unit 133 has also stopped forwarding update commands to the terminal device 41. This means that the terminal device 41 does not display messages indicating the progress of a migration.

The destination server 320, on the other hand, starts drawing screen images in the frame buffer 321a of its RCM 321 upon completion of the migration process. Update commands representing these screen images are transmitted from the destination RCM 321, and the relaying module 130 receives them with its second drawing protocol monitor 132. The reception of update commands from the server 320 signals the selective drawing unit 133 that the migration has finished at the destination end, thus causing it to draw a screen image in the frame buffer 134 in accordance with the received update commands. The relaying module 130 now begins forwarding update commands from the destination RCM 321 to the terminal device 41.

As can be seen from the above, the second embodiment enables the terminal device 41 to work as a remote console, automatically following a migration from one server 310 to another server 320. The second embodiment is configured to stop forwarding update commands to the terminal device 41, not to display messages indicating the progress of the migration. This feature of the second embodiment hides an ongoing migration from the user.

### (c) Third Embodiment

This section describes a third embodiment, which permits RCMs in source and destination servers to share console screen images in their frame buffers. The following description focuses on several differences of this third embodiment from the foregoing second embodiment.

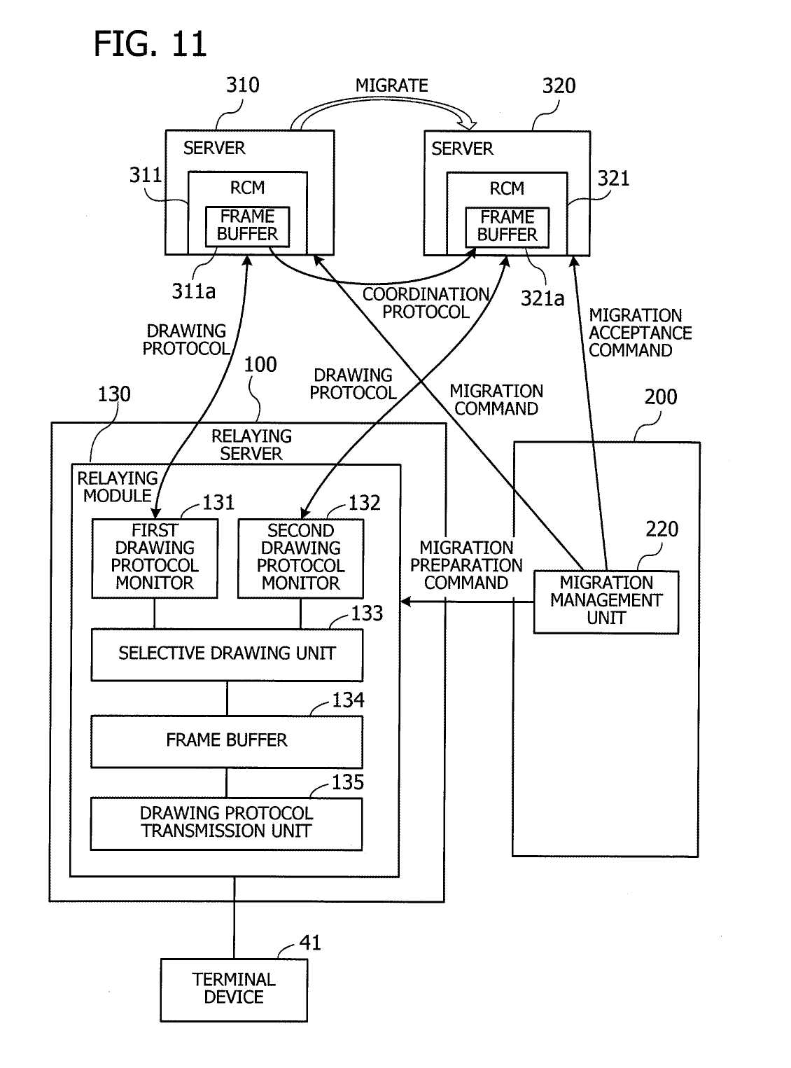

FIG. 11 illustrates an example of a migration process according to the third embodiment. The RCM 311 in the source server 310 in the third embodiment is designed to send image data in its frame buffer 321a to the destination RCM 321 when the source server 320 becomes ready for a migration. The destination RCM 321 stores the received image data in its local frame buffer 321a.

The terminal device 41 may request the destination server 320 to send image data for updating its entire screen. Since the original image data is supplied from the source server 310, the destination server 320 would be able to respond to such a request from the terminal device 41 even if it is immediately after the migration.

### (d) Other Possible Embodiments and Variations

Completion of a migration process may be detected in other ways, not restricted by the methods discussed above. For example, the relaying module 130 may be configured to check the text specified in update commands that the servers 310 and 320 output. Specifically, the specified text may include a particular character string that indicates that the source server 310 is about to shutdown itself or that the destination server 320 is ready for a migration. Referring to, for example, the case of FIG. 10, the selective drawing unit 133 in the relaying module 130 may be modified to recognize that the source server 310 has stopped drawing console screen images (see YES branch at step S124 in FIG.

9) when a character string “Power off” is found in its update command. The relaying module 130 may also be modified to determine that the destination server 320 is ready for a migration (see YES branch at step S122 in FIG. 9) when a character string “Setup Complete” is found in its update command.

It is also possible to use the types of update commands to determine whether the destination server 320 has started drawing screen images. For example, the destination server 320 initially issues update commands specifying text for display and then begins to output update commands for drawing graphic objects. The relaying module 130 may detect this change in the type of update commands as indicating that the destination server 320 has started drawing screen images (see YES branch at step S125 in FIG. 9).

The foregoing embodiments have illustrated how the connection of a remote console is switched with a migration of software in a system that provides IaaS services. Applications of the proposed techniques are, however, not limited by that example of an IaaS-based system. That is, the proposed techniques may be used in other systems to switch the connection of a remote console in accordance with a migration from one physical server to another.

The above sections have exemplified several embodiments and their variations. The described components may be replaced with other components having equivalent functions or may include some additional components or processing operations. Where appropriate, two or more components and features of the above-described embodiments may be combined in different ways.

In one aspect of the embodiments discussed above, the proposed techniques enable the connection of a remote console to be seamlessly changed from one server to another in accordance with a migration of the server OS.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a program that causes a computer to perform a process comprising:
receiving first update commands from a first information processing apparatus and forwarding the received first update commands to a terminal device, the first update commands specifying updates to an image of an operation screen for the first information processing apparatus;
receiving second update commands from a second information processing apparatus to which an operating system of the first information processing apparatus is to migrate, the received second update commands specifying updates to an image of an operation screen for the second information processing apparatus;
detecting completion of a migration of the operating system from the first information processing apparatus to the second information processing apparatus, based on the received first and second update commands; and
starting to forward further second update commands from the second information processing apparatus to the terminal device while stopping the forwarding of the first update commands, when completion of the migration of the operating system is detected.

2. The non-transitory computer-readable storage medium according to claim 1, wherein the process further includes:
drawing an image in a memory in accordance with the first update commands received from the first information processing apparatus, until the migration of the operating system is started;
drawing an image in the memory in accordance with the second update commands received from the second information processing apparatus, after the migration of the operating system is finished; and
transmitting the image currently stored in the memory to the terminal device upon receipt of a request for an image of an operation screen from the terminal device.

3. The non-transitory computer-readable storage medium according to claim 1, wherein the detecting includes determining that the migration of the operating system is finished, upon detection of (a) stopped operation of the operating system on the first information processing apparatus and (b) start of an operating system on the second information processing apparatus.

4. The non-transitory computer-readable storage medium according to claim 3, wherein the detection of (a) stopped operation of the operating system on the first information processing apparatus is done by detecting absence of new first update commands from the first information processing apparatus; and
the detection of (b) start of the operating system on the second information processing apparatus is done by detecting second update commands coming again from the second information processing apparatus after absence of second update commands from the second information processing apparatus.

5. A method for relaying commands, comprising:
receiving first update commands from a first information processing apparatus and forwarding the received first update commands to a terminal device, the first update commands specifying updates to an image of an operation screen for the first information processing apparatus;
receiving second update commands from a second information processing apparatus to which an operating system of the first information processing apparatus is to migrate, the received second update commands specifying updates to an image of an operation screen for the second information processing apparatus;
detecting, by a processor, completion of a migration of the operating system from the first information processing apparatus to the second information processing apparatus, based on the received first and second update commands; and
starting, by the processor, to forward further second update commands from the second information processing apparatus to the terminal device while stopping the forwarding of the first update commands, when completion of the migration of the operating system is detected.

6. A relaying apparatus comprising:
a processor configured to perform a process including:
receiving first update commands from a first information processing apparatus, the first update commands specifying updates to an image of an operation screen for the first information processing apparatus;
receiving second update commands from a second information processing apparatus to which an operating system of the first information processing apparatus is to migrate, the received second update commands specifying updates to an image of an operation screen for the second information processing apparatus;
detecting completion of a migration of the operating system from the first information processing apparatus to the second information processing apparatus, based on the received first and second update commands;
forwarding the received first update commands to a terminal device until the migration of the operating system is started; and
starting to forward further second update commands from the second information processing apparatus to the terminal device while stopping the forwarding of the first update commands, when completion of the migration of the operating system is detected.
